(19) United States
(12) Patent Application Publication
(10) Pub. No.: US 2009/0087566 A1
(43) Pub. Date: Apr. 2, 2009

(54) SUBSTRATE TREATING APPARATUS AND SUBSTRATE TREATING METHOD

(76) Inventor: Masahiro Kimura, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/209,598

(22) Filed: Sep. 12, 2008

(30) Foreign Application Priority Data
Sep. 27, 2007 (JP) 2007-251429
Jul. 29, 2008 (JP) 2008-194789

(51) Int. Cl. B05D 3/10; B05C 11/10

(52) U.S. Cl. 427/299; 118/708

(57) ABSTRACT

A substrate treating apparatus for treating substrates with treating liquids includes a treating tank for storing the treating liquids and receiving the substrates, a holding mechanism movable, while holding the substrates, between a treating position inside the treating tank and an upper position above the treating tank, a first supply device for supplying deionized water into the treating tank, a second supply device for supplying a water-soluble organic solvent in liquid form into the treating tank, a third supply device for supplying a water-insoluble organic solvent in liquid form into the treating tank, and a controller. With the holding mechanism having moved the substrates to the treating position, the controller carries out a deionized water cleaning process to clean the substrates by supplying the deionized water from the first supply device into the treating tank, treats the substrates with the water-soluble organic solvent by supplying the water-soluble organic solvent from the second supply device into the treating tank to replace the deionized water in the treating tank with the water-soluble organic solvent, treats the substrates with a mixture of the water-soluble organic solvent and water-insoluble organic solvent by supplying the water-soluble organic solvent from the second supply device into the treating tank and supplying the water-insoluble organic solvent from the third supply device into the treating tank, and thereafter moves the holding mechanism to the upper position.

### BACKGROUND OF THE INVENTION

(1) Field of the Invention

This invention relates to substrate treating apparatus and substrate treating methods for treating substrates such as semiconductor wafers or glass substrates for liquid crystal displays (hereinafter called simply substrates) with treating liquids.

(2) Description of the Related Art

Conventionally, this type of apparatus includes a plurality of treating tanks, and a transport mechanism for transporting substrates from one treating tank to another. The apparatus successively treats the substrates in different treating tanks with different treating liquids or solutions (see Japanese Unexamined Patent Publication H10-22257 (FIG. 11), for example). Such apparatus performs a series of treatments while moving the substrates successively such that, for example, the substrates have surfaces lightly etched with BHF (buffered hydrofluoric acid) in the first treating tank, and cleaned with deionized water in the second treating tank. The deionized water is replaced with IPA (isopropyl alcohol) in the third treating tank, and the substrates are dried in a solvent vapor atmosphere in the fourth treating tank.

The conventional apparatus with such construction has the following drawback.

With the substrates having fine patterns formed thereon, the fine patterns could collapse when the substrates are moved from one treating tank to another, due to the surface tension of deionized water remaining in the patterns.

### SUMMARY OF THE INVENTION

This invention has been made having regard to the state of the art noted above, and its object is to provide substrate treating apparatus and methods free from collapse of fine patterns formed on substrates, which is achieved by increasing a rate of removing deionized water.

The above object is fulfilled, according to this invention, by a substrate treating apparatus for treating substrates with treating liquids, comprising a treating tank for storing the treating liquids and receiving the substrates; a holding mechanism movable, while holding the substrates, between a treating position inside the treating tank and an upper position above the treating tank; a first supply device for supplying deionized water into the treating tank; a second supply device for supplying a water-soluble organic solvent in liquid form into the treating tank; a third supply device for supplying a water-insoluble organic solvent in liquid form into the treating tank; and a control device for causing the holding mechanism to move the substrates to the treating position, carrying out a deionized water cleaning process to clean the substrates by supplying the deionized water from the first supply device into the treating tank, treating the substrates with the water-soluble organic solvent by supplying the water-soluble organic solvent from the second supply device into the treating tank to replace the deionized water in the treating tank with the water-soluble organic solvent, treating the substrates with a mixture of the water-soluble organic solvent and the water-insoluble organic solvent by supplying the water-soluble organic solvent from the second supply device into the treating tank and supplying the water-insoluble organic solvent from the third supply device into the treating tank, and thereafter moving the holding mechanism to the upper position.

According to this invention, the control device causes the holding mechanism to move the substrates to the treating position, and in this state carries out a deionized water cleaning process to clean the substrates by supplying the deionized water from the first supply device into the treating tank. Next, the control device treats the substrates with the water-soluble organic solvent by supplying the water-soluble organic solvent from the second supply device into the treating tank to replace the deionized water in the treating tank with the water-soluble organic solvent. This step can replace the deionized water adhering to the substrates with the water-soluble organic solvent. However, where fine patterns are formed on the substrates, the deionized water having entered the depths of the patterns cannot be replaced completely. Then, the control device treats the substrates with a mixture of the water-soluble organic solvent and the water-insoluble organic solvent by supplying the water-soluble organic solvent from the second supply device into the treating tank and supplying the water-insoluble organic solvent from the third supply device into the treating tank. The control device thereafter moves the holding mechanism to the upper position to complete treatment of the substrates. In the treatment with the mixture, the water-soluble organic solvent can draw out the deionized water present in the depths of the fine patterns on the substrates. This prevents the deionized water remaining in the fine patterns on the substrates. As a result, collapse of the fine patterns formed on the substrates can be prevented.

In this invention, the control device may be arranged to carry out the treatment with the mixture of the water-soluble organic solvent and the water-insoluble organic solvent, as divided into a first stage of treating the substrates with the water-insoluble organic solvent by supplying the water-insoluble organic solvent from the third supply device into the treating tank to replace the water-soluble organic solvent in the treating tank with the water-insoluble organic solvent, and a second stage of treating the substrates with the mixture of the water-soluble organic solvent and the water-insoluble organic solvent by supplying the water-soluble organic solvent from the second supply device into the treating tank.

First, the water-insoluble organic solvent is supplied to replace the water-soluble organic solvent with the water-insoluble organic solvent. Subsequently, the water-soluble organic solvent is supplied to form a mixture of the water-soluble organic solvent and the water-insoluble organic solvent. With such two-stage treatment also, the water-soluble organic solvent can draw out the deionized water.

In another aspect of the invention, a substrate treating method for treating substrates with treating liquids is provided, which comprises the steps of moving the substrates to a treating position inside a treating tank; carrying out a deionized water cleaning process to clean the substrates by supplying deionized water into the treating tank; treating the substrates with a water-soluble organic solvent by supplying the water-soluble organic solvent into the treating tank to replace the deionized water in the treating tank with the water-soluble organic solvent; treating the substrates with a mixture of the water-soluble organic solvent and a water-insoluble organic solvent by supplying the water-soluble organic solvent and the water-insoluble organic solvent into the treating tank; and moving the substrates to an upper position above the treating tank.

According to this invention, the substrates are moved to the treating position inside the treating tank, and a deionized water cleaning process is carried out to clean the substrates by supplying the deionized water into the treating tank. Subsequently, the substrates are treated with the water-soluble organic solvent by replacing the deionized water in the treating tank with the water-soluble organic solvent. This step can replace the deionized water adhering to the substrates with the water-soluble organic solvent. However, where fine patterns are formed on the substrates, the deionized water having entered the depths of the patterns cannot be replaced completely. Thereafter the substrates are treated with a mixture of the water-soluble organic solvent and the water-insoluble organic solvent. The substrates are moved to the upper position above the treating tank to complete treatment of the substrates. In the treatment with the mixture, the water-soluble organic solvent can draw out the deionized water present in the depths of the fine patterns on the substrates. This prevents the deionized water remaining in the fine patterns on the substrates. As a result, collapse of the fine patterns formed on the substrates can be prevented.

In a further aspect of the invention, a substrate treating apparatus for treating substrates with treating liquids is provided, which comprises a treating tank including an inner tank for storing the treating liquids, and an outer tank for collecting the treating liquids overflowing the inner tank; a holding mechanism movable, while holding the substrates, between a treating position inside the treating tank and an upper position above the treating tank; a supply pipe interconnecting the inner tank and the outer tank for circulating the treating liquids; a branch pipe shunted from the supply pipe; a separating device mounted on the branch pipe for separating deionized water and a solvent in the treating liquids, and discharging the deionized water from the treating liquids; an injection pipe connected to the supply pipe for injecting deionized water in a position down-stream of the separating device; a water-soluble organic solvent injecting device for injecting a water-soluble organic solvent into the injection pipe; a water-insoluble organic solvent injecting device for injecting a water-insoluble organic solvent into the injection pipe; and a control device for causing the holding mechanism to move the substrates to the treating position, carrying out a deionized water cleaning process to clean the substrates with deionized water in the treating tank by supplying the deionized water from the injection pipe and the supply pipe into the treating tank, replacing the deionized water with the water-soluble organic solvent by supplying the water-soluble organic solvent from the water-soluble organic solvent injecting device through the injection pipe and the supply pipe into the treating tank, switching passage to the branch pipe and causing the separating device to remove the deionized water from the treating liquids, treating the substrates with a mixture of the water-soluble organic solvent and the water-insoluble organic solvent by supplying the water-insoluble organic solvent from the water-insoluble organic solvent injecting device through the injection pipe and the supply pipe into the treating tank and supplying a small quantity of the water-soluble organic solvent from the water-soluble organic solvent injecting device through the injection pipe and the supply pipe into the treating tank, and thereafter moving the holding mechanism to the upper position.

According to this invention, the control device causes the holding mechanism to move the substrates to the treating position, and in this state carries out a deionized water cleaning process to clean the substrates with deionized water. Then, the control device replaces the deionized water with the water-soluble organic solvent by supplying the water-soluble organic solvent from the water-soluble organic solvent injecting device through the injection pipe and the supply pipe into the treating tank. This step can replace the deionized water adhering to the substrates with the water-soluble organic solvent. However, where fine patterns are formed on the substrates, the deionized water having entered the depths of the patterns cannot be replaced completely. Then, the control device switches passage to the branch pipe and causes the separating device to remove the deionized water from the treating liquids, treats the substrates with a mixture of the water-soluble organic solvent and the water-insoluble organic solvent by supplying the water-insoluble organic solvent from the water-insoluble organic solvent injecting device through the injection pipe and the supply pipe into the treating tank and supplying a small quantity of the water-soluble organic solvent from the water-soluble organic solvent injecting device through the injection pipe and the supply pipe into the treating tank, and thereafter moves the holding mechanism to the upper position. In the treatment with the mixture, the water-soluble organic solvent can draw out the deionized water present in the depths of the fine patterns on the substrates. This prevents the deionized water remaining in the fine patterns on the substrates. As a result, collapse of the fine patterns formed on the substrates can be prevented.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a substrate treating apparatus according to this invention;

FIG. 2 is a view in vertical section showing an outline of a static mixer;

FIG. 3 is a view in vertical section showing an outline of an oil-water separation filter;

FIG. 4 is a flow chart of operation;

FIGS. 5A-5D are schematic views illustrating action of organic solvents;

FIGS. 6A-6D are schematic views illustrating action of the organic solvents; and

FIG. 7 is a view illustrating a relationship between IPA and deionized water.

### DESCRIPTION OF THE PREFERRED EMBODIMENTS

An embodiment of this invention will be described in detail hereinafter with reference to the drawings.

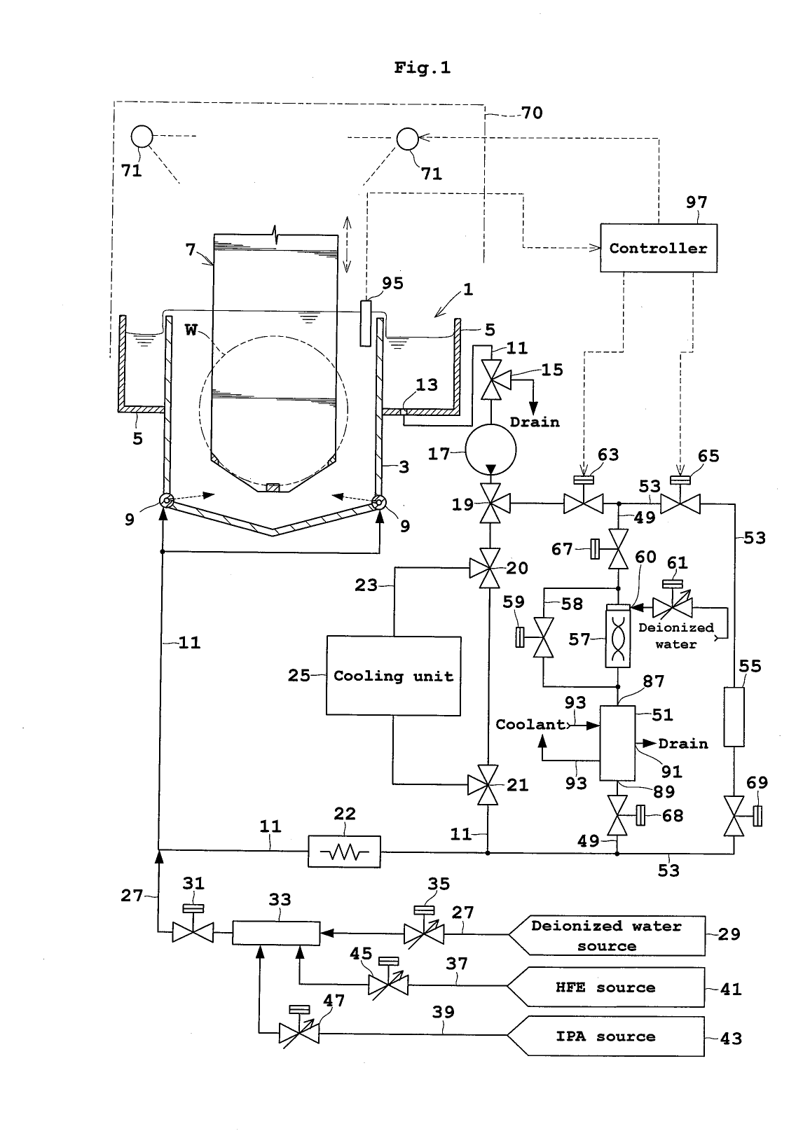

FIG. 1 is a block diagram showing an outline of a substrate treating apparatus according to this invention.

The substrate treating apparatus in this embodiment includes a treating tank 1, which in turn includes an inner tank 3 and an outer tank 5. The inner tank 3 stores a treating liquid or solution, and can receive wafers W held by a lifter 7. The lifter 7, which corresponds to the “holding mechanism” in this invention, includes support elements arranged on lower positions of an arm portion for contacting lower edges of the wafers W and supporting the wafers W in upstanding posture. The lifter 7 is vertically movable between a “treating position” inside the inner tank 3 and an “upper position” above the inner tank 3. The inner tank 3 stores deionized water, solvents or a mixture thereof as a treating liquid or solution, and the treating liquid overflowing the inner tank 3 is collected in the outer tank 5 surrounding an upper portion of the inner tank 3. The inner tank 3 has two jet pipes 9 disposed at opposite sides in the bottom thereof for supplying the treating liquid into the inner tank 3.

The jet pipes 9 are connected to one end of a supply pipe 11 having the other end connected to a drain port 13 formed in the outer tank 5. The supply pipe 11 has a three-way valve 15, a pump 17, three-way valves 19-21 and an in-line heater 22 arranged in order from upstream, i.e. adjacent the outer tank 5. The three-way valve 15 is switchable between circulation and drain of the treating liquid. The pump 17 circulates the treating liquid, and the three-way valve 19 is switchable between circulation of the treating liquid and removal of deionized water (to be described in detail hereinafter). The three-way valves 20 and 21 are switchable between circulation and cooling of the treating liquid (to be described in detail hereinafter). The in-line heater 22 heats the treating liquid circulating through the supply pipe 11 to a predetermined temperature.

The three-way valves 20 and 21 have a first branch pipe 23 connected thereto and shunted from the supply pipe 11. The first branch pipe 23 has a cooling unit 25 mounted thereon. The cooling unit 25 has a function to cool the treating liquid circulating through the first branch pipe 23 to a predetermined temperature.

The supply pipe 11 has one end of an injection pipe 27 connected to a position thereof downstream of the in-line heater 22 and upstream of the jet pipes 9. The other end of the injection pipe 27 is connected to a deionized water source 29. The injection pipe 27 has a control valve 31, a mixing valve 33 and a flow control valve 35 arranged in order from downstream to upstream. The control valve 31 controls supply and cutoff of deionized water, solvents or a treating solution of the solvents in deionized water. The mixing valve 33 has, connected thereto, one end of each of two chemical pipes 37 and 39, with the other ends thereof connected to an HFE source 41 and an IPA source 43, respectively. The two chemical pipes 37 and 39 have flow control valves 45 and 47 for adjusting flow rate, respectively. The mixing valve 33 has a function to mix HFE (hydrofluoroether) which is a water-insoluble organic solvent, and/or IPA (isopropyl alcohol) which is a water-soluble organic solvent.

The jet pipes 9, supply pipe 11 and injection pipe 27 correspond to the “first supply device” in this invention. The jet pipes 9, supply pipe 11, injection pipe 27, mixing valve 33 and chemical pipe 39 correspond to the “second supply device” in this invention. The jet pipes 9, supply pipe 11, injection pipe 27, mixing valve 33 and chemical pipe 37 correspond to the “third supply device” in this invention.

The supply pipe 11 has a second branch pipe 49 connected to positions upstream and downstream of the cooling unit 25. The second branch pipe 49 has an oil-water separation filter 51 for separating the deionized water and solvent in the treating liquid. The supply pipe 11 further includes a third branch pipe 53 extending parallel to the second branch pipe 49. The third branch pipe 53 communicates with the second branch pipe 49 in positions upstream and downstream of the oil-water separation filter 51. The third branch pipe 53 has an adsorption filter 55 for adsorbing and removing deionized water from the treating liquid. The adsorption filter 55 is formed of a molecular sieve, activated carbon, alumina or the like, and has a function to adsorb and remove even a trace quantity of deionized water from the treating liquid.

The second branch pipe 49 noted above has a static mixer 57 disposed upstream of the oil-water separation filter 51. A fourth branch pipe 58 communicates with the second branch pipe 49 in positions upstream of this static mixer 57, and downstream of the static mixer 57 and upstream of the oil-water separation filter 51. The fourth branch pipe 58 includes a control valve 59 for controlling circulation therethrough. The static mixer 57 has an injection portion 60 disposed in an upstream position thereof for injecting deionized water into the treating liquid circulating through the second branch pipe 49. A flow control valve 61 is provided for controlling a flow rate of deionized water to the injection portion 60. As described in detail hereinafter, the static mixer 57 has no actuator, but agitates and mixes fluids by action of division, turning and reversal.

A control valve 63 is disposed between the three-way valve 19 and second branch pipe 49, and a control valve 65 is mounted on the third branch pipe 53 upstream of the adsorption filter 55. The second branch pipe 49 has a control valve 67 disposed in the most upstream position thereof, and a control valve 68 in the most downstream position. The third branch pipe 53 has a control valve 69 disposed downstream of the adsorption filter 55.

The oil-water separation filter 51 and adsorption filter 55 correspond to the “separating device” in this invention.

The treating tank 1 described hereinbefore is enclosed by a chamber 70 to be shielded from ambient atmosphere. A pair of solvent nozzles 71 are arranged in upper positions inside the chamber 70. The solvent nozzles 71 supply a vapor of IPA from a solvent vapor generator not shown. The vapor of IPA is supplied to upper areas above the treating tank 1, to fill the interior of chamber 71 with solvent vapor atmosphere. An openable upper cover, not shown, is disposed at the top of the chamber 70, which is opened for the lifter 7 to move into and out of the chamber 70.

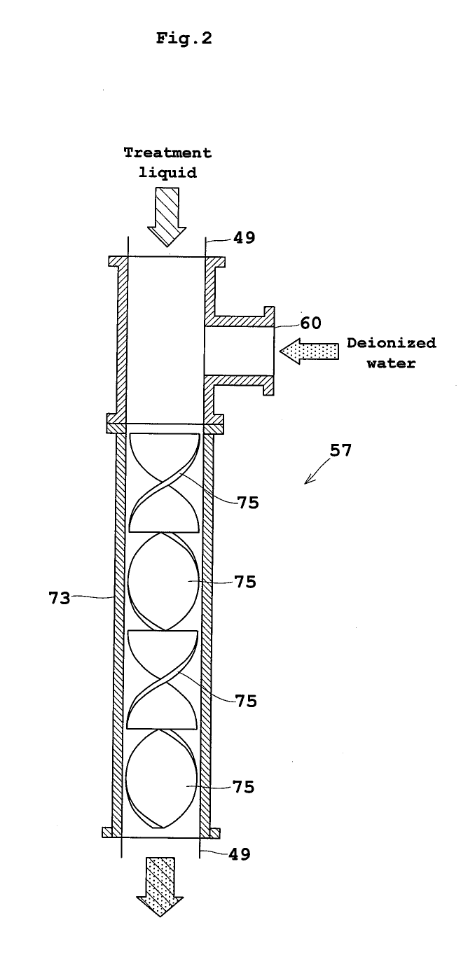

Next, reference is made to FIG. 2 which is a view in vertical section showing an outline of the static mixer 57.

The static mixer 57 includes a body portion 73 and a plurality of elements 75 arranged in the body portion 73. Each element 75 is in the form of a rectangular plate member twisted 180 degrees. Adjoining elements 75 are twisted in opposite directions. The static mixer 57 has the above-noted injection portion 60 disposed in the upstream position thereof for injecting deionized water into the treating liquid, and agitates and mixes these liquids by action of division, turning and reversal. Particularly where the organic solvent is water-insoluble such as HFE (hydrofluoroether) that does not dissolve completely in deionized water, the deionized water can be separated efficiently by passing the mixture through the oil-water separation filter 51 after mixing deionized water and solvent in the static mixer 57.

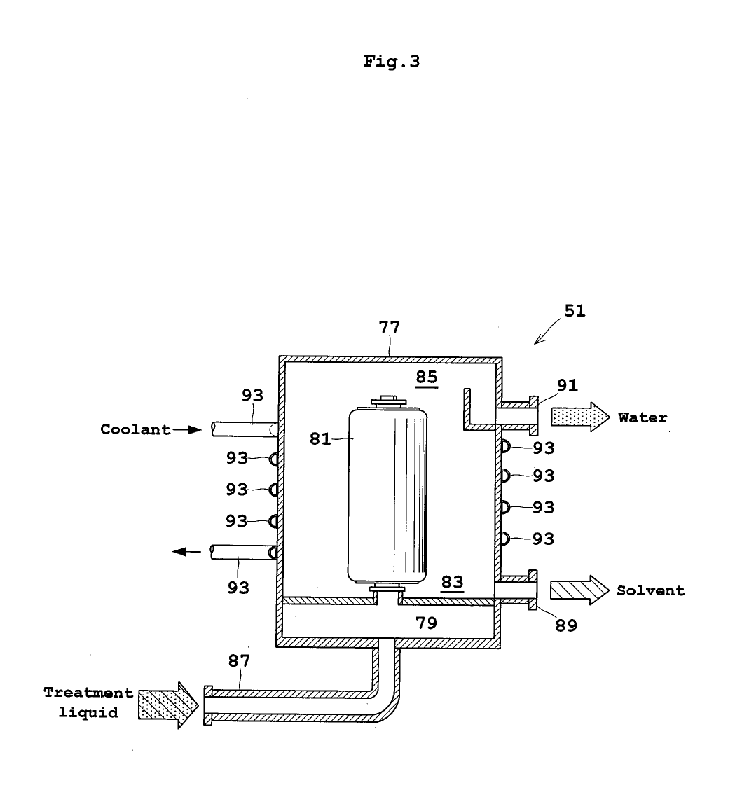

Next, reference is made to FIG. 3 which is a view in vertical section showing an outline of the oil-water separation filter 51.

The oil-water separation filter 51 includes a housing 77, a liquid introducing portion 79 in the bottom of the housing 77, a filter 81 for filtering the treating liquid from the liquid introducing portion 79, a first storage portion 83 for storing part having a high specific gravity of the liquid having passed the filter 81, a second storage portion 85 for storing part having a low specific gravity, an inflow portion 87 through which the treating liquid flows into the liquid introducing portion 79, a first discharge portion 89 for discharging the liquid from the first storage portion 83, a second discharge portion 91 for discharging the liquid from the second storage portion 85, and a cooling pipe 93 arranged along the outer wall of housing 77 for indirectly cooling the filter 81. The inflow portion 87 is located upstream with respect to the second branch pipe 49, and the first discharge portion 89 downstream with respect to the second branch pipe 49. The filter 81 is a microfiber filter having a function to trap a differentiated free liquid and flocculate the liquid into coarse masses. The free liquid differentiated to the order of microns is flocculated to the order of millimeters, thereby to be instantaneously distributed into a perfect bilayer system by specific gravity difference. The efficiency of oil-water separation can be improved by cooling the filter 81 with the cooling pipe 93.

The inner tank 3 has a concentration meter 95 disposed in an upper position thereof for measuring a deionized water concentration in the treating liquid. The concentration meter 95 may be the infrared absorption type, for example.

A controller 97, which corresponds to the “control device” in this invention, performs an overall control of the apparatus including the vertical movement of the lifter 7, operation and stopping of the pump 17, temperature control of the in-line heater 22, flow control of the flow control valves 35, 45, 47 and 61, opening and closing of the control valve 31, switching control of the three-way valves 15 and 19-21, and opening and closing of the control valves 59, 63, 65, 67, 68 and 69.

The controller 97 controls the various components noted above to carry out a “deionized water cleaning process” for moving the lifter 7 to the treating position and supplying deionized water as treating liquid, a “replacing process” for supplying IPA to the treating liquid to replace the deionized water with IPA, a “cooling process” for causing the cooling unit 25 to cool the treating liquid, and a “separating and removing process” for causing the oil-water separation filter 51 to remove deionized water from the treating liquid. Subsequently, the controller 97 carries out an “adsorbing and removing process” for causing the adsorption filter 55 to adsorb and remove deionized water from the treating liquid. Then, the controller 97 carries out a “replacement promoting process” for injecting HFE into the treating liquid to replace IPA with HFE. When the deionized water concentration in the treating liquid falls to or below a predetermined value, the controller 97 carries out a “finishing process” for injecting a small quantity (e.g. about 5 to 10%) of IPA again to use the mixture of HFE and IPA as treating liquid, and causing the adsorption filter 55 to further adsorb and remove deionized water from the treating liquid. However, during the “replacing process” and “separating and removing process”, the treating liquid is passed through the oil-water separation filter 51 after operating the static mixer 57 to agitate and mix the deionized water and solvent by action of division, turning and reversal, thereby improving the efficiency of separation by the oil-water separation filter 51. The static mixer 57 is effective particularly where the organic solvent is HFE which does not easily dissolve in deionized water. After the “finishing process”, the organic solvent vapor is supplied from the solvent nozzles 71 to form a solvent atmosphere in the chamber 70, and the lifter 7 is pulled up from the treating tank 1 to dry the wafers W.

It is preferable to confirm the saturation solubility of the organic solvent in the treating liquid before the “adsorbing and removing process”, but the concentration meter 95 can be used as substitution. A specific value of deionized water concentration is 0.1 [%] or less, for example. When the “adsorbing and removing process” is carried out while the deionized water concentration is still high, the adsorption filter 55 will lose water-adsorbing power in a short time, necessitating frequent changes of the adsorption filter 55. It is desirable to avoid such an inconvenience.

In the “replacement promoting process”, preferably, the controller 97 operates the flow control valve 45 to inject HFE at a low flow rate. Then, the inner tank 3 may be filled with HFE while maintaining an interface with the IPA stored in the inner tank 3. This ensures an efficient replacement of IPA with HFE.

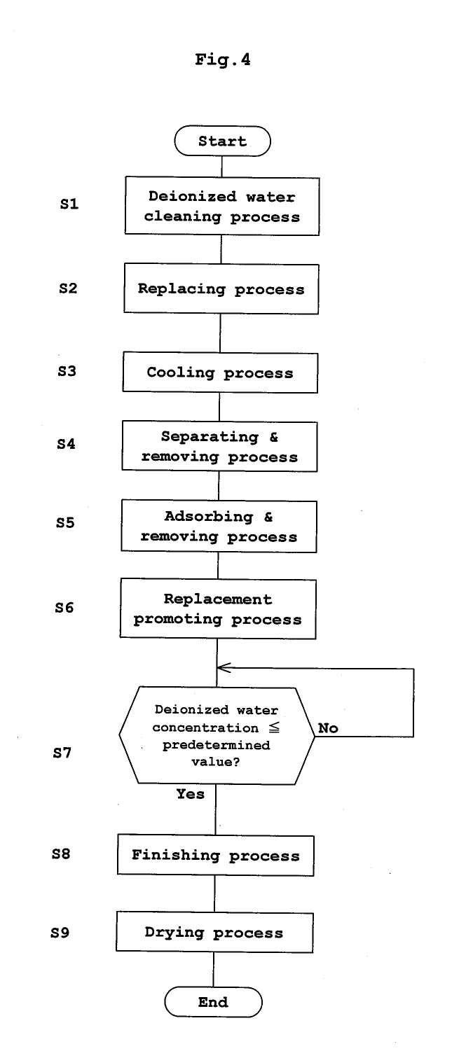

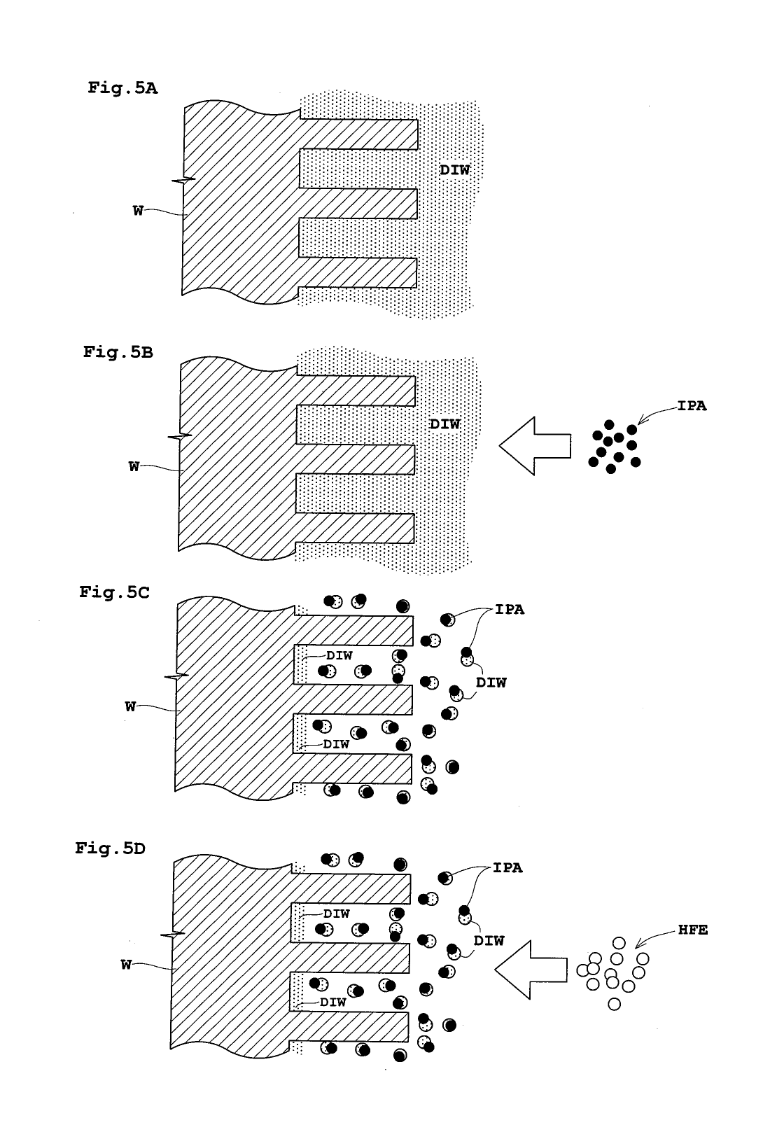

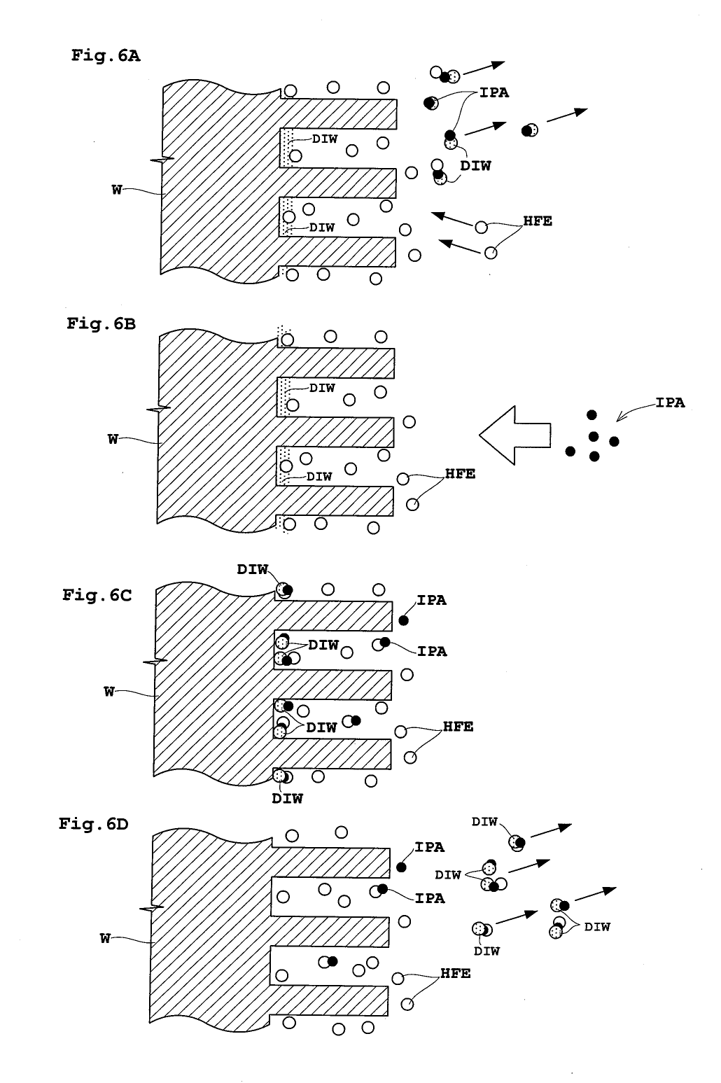

Next, operation of the above substrate treating apparatus will be described with reference to FIGS. 4 through 6. FIG. 4 is a flow chart of operation. FIGS. 5A-5D and 6A-6D are schematic views illustrating action of the organic solvents.

Step S1

The controller 97 switches the three-way valve 15 to a position for allowing circulation, switches the three-way valves 19-21 to positions for communication with the supply pipe 11, opens the control valve 31, and adjusts the flow control valve 35 to supply deionized water in a predetermined flow rate from the deionized water source 29 through the injection pipe 27 and supply pipe 11 to the inner tank 3. After filling all of the inner tank 3, outer tank 5 and supply pipe 11 with deionized water, the controller 97 operates the pump 17 and in-line heater 22 to heat the deionized water to a predetermined temperature (e.g. 60° C.). After the predetermined temperature is reached, the controller 97 lowers the lifter 7 from a standby position outside the chamber 70 to the treating position, and maintains the lifter 7 in the treating position for a predetermined time. As a result, the wafers W are cleaned with the deionized water heated to the predetermined temperature. At this time, as schematically shown in FIG. 5A, the deionized water is present in the fine patterns on the wafers W.

Step S2

The controller 97 stops the in-line heater 22 and pump 17, switches the three-way valve 15 to a drain position, and closes the flow control valve 35. The controller 97 adjusts the flow control valve 47 to a predetermined flow rate to supply IPA to the supply pipe 11 (FIG. 5B). After the inner tank 3 and outer tank 5 are filled with IPA, the controller 97 switches the three-way valve 15 to the position for communication with the supply pipe 11, and operates the pump 17. As a result, a large part of deionized water in the treating liquid is discharged, and IPA is mixed into the treating liquid whereby the deionized water is replaced by IPA. In this state, as schematically shown in FIG. 5C, although a large part of deionized water DIW in the fine patterns on the wafers W is replaced by IPA, the part of deionized water DIW present in the depths of the fine patterns cannot be replaced completely by IPA.

Step S3

The controller 97 switches the three-way valves 20 and 21 to positions for communication with the first branch pipe 23, and causes the cooling unit 25 to cool the treating liquid to a predetermined temperature. By cooling the treating liquid, deionized water is rendered not easily soluble in IPA.

Step S4

The controller 97 opens the control valves 63, 67 and 68, and switches the three-way valve 19 to a position for communication with the second branch pipe 49. As a result, the treating liquid passes through the oil-water separation filter 51 after IPA and deionized water are fully mixed by the static mixer 57.

At this time, the flow control valve 61 may be adjusted to inject a small quantity of deionized water into the treating liquid flowing through the static mixer 57. A deionized water concentration in the solvent below a certain value would lower the efficiency of the oil-water separation filter 51 separating deionized water and solvent. Deionized water is positively injected and mixed into the treating liquid having a reduced deionized water concentration, so that the oil-water separation filter 51 may separate deionized water below the certain value as drawn out by the injected deionized water.

After executing the above process for a predetermined time, the controller 97 opens the control valve 59 to switch the channel to the fourth branch pipe 58, providing a bypass for the treating liquid to circumvent the static mixer 57. As a result, the treating liquid with a reduced deionized water concentration passes only through the oil-water separation filter 51. It is possible to omit the fourth branch pipe 58 so that the treating liquid may always flow through the static mixer 57.

Step S5

The controller 97 opens the control valves 65 and 69, and closes the control valves 67 and 68. As a result, the treating liquid (largely HFE) with a reduced deionized water concentration flows into the third branch pipe 53. A small quantity of deionized water remaining in the treating liquid is adsorbed and removed by the adsorption filter 55.

Step S6

After executing the above adsorbing and removing process for a predetermined time, the controller 97 switches the control valve 15 to the drain position, and switches three-way valves 19-21 to the positions for communication with the supply pipe 11. Further, the controller 97 adjusts the flow control valve 45 to supply HFE at a low flow rate to the inner tank 3 (FIG. 5D). As a result, IPA is gradually pushed up by HFE without mixing therewith, to be discharged from the inner tank 3 and replaced by HFE. However, a small quantity of deionized water still remains in the treating liquid and in the fine patterns on the wafers W (FIG. 6A). That is, HFE can permeate into the depths of the fine patterns more easily than IPA but, since HFE is insoluble in deionized water, the deionized water remains in the depths of the fine pattern. After the inner tank 3 is filled with HFE, the controller 97 closes the control valve 31 and flow control valve 45, switches the three-way valve 19 for communication with the second branch pipe 49, opens the control valves 67 and 68, and closes the control valve 58. As a result, as in step S4 above, the treating liquid including HFE circulates through the static mixer 57 and oil water separation filter 51 to have the deionized water removed. After a predetermined time of deionized water removal by the oil-water separation filter 51, the controller 97 switches the channel as in step S5 for adsorption and removal by the adsorption filter 55.

Step S7

The controller 97 refers to the concentration meter 95, and performs the adsorbing process with the adsorption filter 55 until the deionized water concentration in the treating liquid falls to or below a predetermined value. The predetermined value is 0.1 [%] or less, for example.

Step S8

The controller 97 carries out the finishing process by injecting IPA again into the treating liquid with a reduced deionized water concentration. Specifically, the controller 97 opens the control valve 31, and adjusts the flow control valve 47 to inject a small quantity of IPA into the treating liquid (FIG. 6B). Its concentration is about 5 to 10%, for example. The adsorbing and removing action of the adsorption filter 55 is maintained in this state, whereby a slight quantity of deionized water is removed from the treating liquid including mostly HFE and a small quantity of IPA. As a result, the deionized water remaining also in the fine patterns on the wafers W can be drawn out and removed. That is, as shown in FIG. 6C, IPA which is soluble in both deionized water and HFE takes in, as if to join together, the deionized water remaining in the depths of the fine patterns on the wafer W and HFE having permeated into the depths of the fine patterns. Thus, as shown in FIG. 6D, IPA and deionized water are removed from the wafer W by HFE.

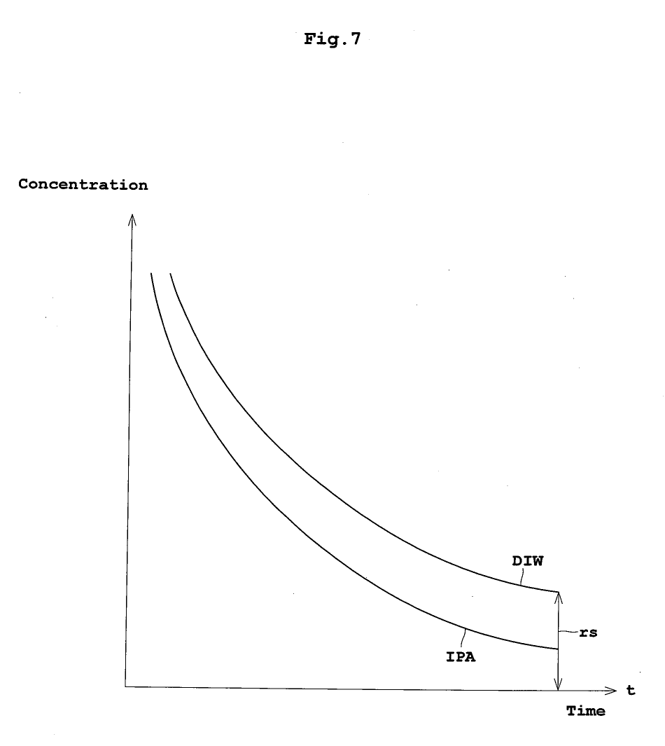

The relationship between IPA and deionized water is as shown in FIG. 7. FIG. 7 is a view illustrating the relationship between IPA and deionized water.

As the concentration of IPA lowers in the process described above, deionized water DIW dissolving in IPA decreases in quantity, whereby the concentration of deionized water DIW does not fall below a certain value. As a result, deionized water DIW will remain (as referenced “rs”). Thus, as described above, after HFE is supplied, IPA is supplied again to dissolve the remainder “rs” of deionized water DIW in IPA.

Step S9

After executing the above process for a predetermined time, the controller 97 supplies the solvent vapor from the nozzles 71 to form a solvent atmosphere around the treating tank 1. The lifter 7 is raised to volatilize HFE adhering to the wafers W and dry the wafers W.

According to the apparatus in this embodiment, as described above, the controller 97 causes the lifter 7 to move the wafers W to the treating position, and carries out the deionized water cleaning process to clean the wafers W in the treating tank 1 with deionized water. Then, the controller 97 carries out the replacing process to introduce IPA from the mixing valve 33 into the supply pipe 11 and replace the deionized water with IPA. This step can replace the deionized water adhering to the wafers W with IPA. However, where fine patterns are formed on the wafers W, the deionized water having entered the depths of the patterns cannot be replaced completely. Subsequently, the controller 97 switches the channel to the second branch pipe 49, carries out the separating and removing process for causing the oil-water separation filter 51 to remove the deionized water from the treating liquid, and carries out the replacement promoting process by introducing HFE from the mixing valve 33 into the supply pipe 11. After introducing a small quantity of IPA from the mixing valve 33 into the supply pipe 11 for the finishing process, the controller 97 moves the lifter 7 to the upper position. In the finishing process, the small quantity of IPA can draw out the deionized water present in the depths of the fine patterns on the wafers W. This prevents the deionized water remaining in the fine patterns on the wafers W. As a result, collapse of the fine patterns formed on the wafers W can be prevented.

This invention is not limited to the foregoing embodiment, but may be modified as follows:

(1) The foregoing embodiment employs the circulating system having the inner tank 3 and outer tank 5 connected through the supply pipe 11, with the pump 17 circulating the treating liquid therethrough. This invention is not limited to this circulating system.

That is, the construction may be modified to drain the treating liquid through the three-way valve 15, without returning the treating liquid collected in the outer tank 5 to the supply pipe 11, and to omit the cooling unit 25, oil-water separation filter 51 and adsorption filter 55. With such a construction, treatment is carried out as follows.

The controller 97 causes the lifter 7 to move the wafers W to the treating position, and carries out the deionized water cleaning process to clean the wafers W by supplying deionized water from the mixing valve 33 to the treating tank 1 while draining the treating liquid from the outer tank 5. Next, the controller 97 supplies IPA from the mixing valve 33 to the treating tank 1 by way of the replacing process to replace the deionized water in the treating tank 1 with IPA. This step can replace the deionized water adhering to the wafers W with IPA. However, where fine patterns are formed on the wafers W, the deionized water having entered the depths of the patterns cannot be replaced completely. Next, the controller 97 supplies HFE from the mixing valve 33 to the treating tank 1 to replace IPA in the treating tank 1 with HFE while draining the treating liquid from the outer tank 5, and carry out the replacement promoting process for the wafers W by HFE. Further, the controller 97 supplies IPA from the mixing valve 33 to the treating tank 1, while draining the treating liquid from the outer tank 5, to carry out the finishing process with a mixture of IPA and HFE. Then, the controller 97 moves the lifter 7 to the upper position to complete treatment of the wafers W. In the finishing process, IPA can draw out the deionized water present in the depths of the fine patterns on the wafers W. This prevents the deionized water remaining in the fine patterns on the wafer W. As a result, collapse of the fine patterns formed on the wafers W can be prevented.

(2) The foregoing embodiment uses IPA as water-soluble organic solvent, and HFE as water-insoluble organic solvent. This invention is not limited to these organic solvents, but may use other organic solvents.

(3) The foregoing embodiment provides the cooling unit 25 for cooling the treating liquid. However, the cooling unit 25 may be omitted, so that deionized water may be removed without cooling the treating liquid. This simplifies the apparatus construction.

(4) The foregoing embodiment supplies a vapor of IPA from the solvent nozzles 71. Instead, a vapor of HFE may be supplied. The solvent nozzles 71 may be omitted, and the wafers W having undergone the finishing process may be unloaded as they are from the apparatus. This simplifies the apparatus construction.

(5) In the foregoing embodiment, after replacing deionized water with IPA, HFE is supplied and then a small quantity of IPA is supplied. Instead, after replacing deionized water with IPA, HFE and a small quantity of IPA may be supplied simultaneously. That is, a treating solution of HFE including a small quantity of IPA may be supplied. This will produce the same effect as the foregoing embodiment.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for treating substrates with treating liquids, comprising:
a treating tank for storing the treating liquids and receiving the substrates;
a holding mechanism movable, while holding the substrates, between a treating position inside said treating tank and an upper position above said treating tank;
a first supply device for supplying deionized water into said treating tank;
a second supply device for supplying a water-soluble organic solvent in liquid form into said treating tank;
a third supply device for supplying a water-insoluble organic solvent in liquid form into said treating tank; and
a control device for causing said holding mechanism to move the substrates to the treating position, carrying out a deionized water cleaning process to clean the substrates by supplying the deionized water from said first supply device into said treating tank, treating the substrates with the water-soluble organic solvent by supplying the water-soluble organic solvent from said second supply device into said treating tank to replace the deionized water in said treating tank with the water-soluble organic solvent, treating the substrates with a mixture of the water-soluble organic solvent and the water-insoluble organic solvent by supplying the water-soluble organic solvent from said second supply device into said treating tank and supplying the water-insoluble organic solvent from said third supply device into said treating tank, and thereafter moving said holding mechanism to the upper position.

2. The apparatus according to claim 1, wherein said control device is arranged to carry out the treatment with the mixture of the water-soluble organic solvent and the water-insoluble organic solvent, as divided into a first stage of treating the substrates with the water-insoluble organic solvent by supplying the water-insoluble organic solvent from said third supply device into said treating tank to replace the water-soluble organic solvent in said treating tank with the water-insoluble organic solvent, and a second stage of treating the substrates with the mixture of the water-soluble organic solvent and the water-insoluble organic solvent by supplying the water-soluble organic solvent from said second supply device into said treating tank.

3. The apparatus according to claim 1, further comprising:
a chamber enclosing said treating tank; and
a fourth supply device for supplying a solvent vapor into said chamber;
wherein said control device is arranged to form a solvent atmosphere in said chamber by supplying the solvent vapor from said fourth supply device, after the treatment with said mixture and before moving said holding mechanism to the upper position.

4. The apparatus according to claim 2, further comprising:
a chamber enclosing said treating tank; and
a fourth supply device for supplying a solvent vapor into said chamber;
wherein said control device is arranged to form a solvent atmosphere in said chamber by supplying the solvent vapor from said fourth supply device, after the treatment with said mixture and before moving said holding mechanism to the upper position.

5. The apparatus according to claim 1, wherein said second supply device is arranged to supply IPA (isopropyl alcohol) as the water-soluble organic solvent, and said third supply device is arranged to supply HFE (hydrofluoroether) as the water-insoluble organic solvent.

6. The apparatus according to claim 5, wherein IPA (isopropyl alcohol) in said mixture is at most 10%.

7. A substrate treating method for treating substrates with treating liquids, comprising the steps of:
moving the substrates to a treating position inside a treating tank;
carrying out a deionized water cleaning process to clean the substrates by supplying deionized water into the treating tank;
treating the substrates with a water-soluble organic solvent by supplying the water-soluble organic solvent into said treating tank to replace the deionized water in the treating tank with the water-soluble organic solvent;
treating the substrates with a mixture of the water-soluble organic solvent and a water-insoluble organic solvent by supplying the water-soluble organic solvent and the water-insoluble organic solvent into the treating tank; and
moving the substrates to an upper position above the treating tank.

8. The method according to claim 1, wherein the step of treating with the mixture of the water-soluble organic solvent and the water-insoluble organic solvent includes the steps of:
treating the substrates with the water-insoluble organic solvent by supplying the water-insoluble organic solvent into the treating tank to replace the water-soluble organic solvent in the treating tank with the water-insoluble organic solvent; and
treating the substrates with the mixture of the water-soluble organic solvent and the water-insoluble organic solvent by supplying the water-soluble organic solvent into the treating tank.

9. The method according to claim 7, wherein said water-soluble organic solvent is IPA (isopropyl alcohol), and said water-insoluble organic solvent is HFE (hydrofluoroether), IPA (isopropyl alcohol) in said mixture being at most 10%.

10. The method according to claim 8, wherein said water-soluble organic solvent is IPA (isopropyl alcohol), and said water-insoluble organic solvent is HFE (hydrofluoroether), IPA (isopropyl alcohol) in said mixture being at most 10%.

11. A substrate treating apparatus for treating substrates with treating liquids, comprising:
a treating tank including an inner tank for storing the treating liquids, and an outer tank for collecting the treating liquids overflowing the inner tank;
a holding mechanism movable, while holding the substrates, between a treating position inside said treating tank and an upper position above said treating tank;
a supply pipe interconnecting said inner tank and said outer tank for circulating the treating liquids;
a branch pipe shunted from said supply pipe;
a separating device mounted on said branch pipe for separating deionized water and a solvent in the treating liquids, and discharging the deionized water from the treating liquids;
an injection pipe connected to said supply pipe for injecting deionized water in a position downstream of said separating device;
a water-soluble organic solvent injecting device for injecting a water-soluble organic solvent into said injection pipe;
a water-insoluble organic solvent injecting device for injecting a water-insoluble organic solvent into said injection pipe; and
a control device for causing said holding mechanism to move the substrates to the treating position, carrying out a deionized water cleaning process to clean the substrates with deionized water in the treating tank by supplying the deionized water from said injection pipe and said supply pipe into said treating tank, replacing the deionized water with the water-soluble organic solvent by supplying the water-soluble organic solvent from said water-soluble organic solvent injecting device through said injection pipe and said supply pipe into said treating tank, switching passage to said branch pipe and causing said separating device to remove the deionized water from the treating liquids, treating the substrates with a mixture of the water-soluble organic solvent and the water-insoluble organic solvent by supplying the water-insoluble organic solvent from said water-insoluble organic solvent injecting device through said injection pipe and said supply pipe into said treating tank and supplying a small quantity of the water-soluble organic solvent from said water-soluble organic solvent injecting device through said injection pipe and said supply pipe into said treating tank, and thereafter moving said holding mechanism to the upper position.

12. The apparatus according to claim 11, wherein said control device is arranged to carry out the treatment with the mixture of the water-soluble organic solvent and the water-insoluble organic solvent, as divided into a first stage of treating the substrates by supplying the water-insoluble organic solvent from said water-insoluble organic solvent injecting device through said injection pipe and said supply pipe into said treating tank, and a second stage of treating the substrates with the mixture of the water-soluble organic solvent and the water-insoluble organic solvent by supplying a small quantity of the water-soluble organic solvent from said water-soluble organic solvent injecting device through said injection pipe and said supply pipe into said treating tank.

13. The apparatus according to claim 11, further comprising:
a chamber enclosing said treating tank; and
a solvent vapor supply device for supplying a solvent vapor into said chamber;
wherein said control device is arranged to form a solvent atmosphere in said chamber by supplying the solvent vapor from said solvent vapor supply device, after the treatment with said mixture and before moving said holding mechanism to the upper position.

14. The apparatus according to claim 12, further comprising:
a chamber enclosing said treating tank; and
a solvent vapor supply device for supplying a solvent vapor into said chamber;
wherein said control device is arranged to form a solvent atmosphere in said chamber by supplying the solvent vapor from said solvent vapor supply device, after the treatment with said mixture and before moving said holding mechanism to the upper position.

15. The apparatus according to claim 11, wherein said second supply device is arranged to supply IPA (isopropyl alcohol) as the water-soluble organic solvent, and said third supply device is arranged to supply HFE (hydrofluoroether) as the water-insoluble organic solvent.

16. The apparatus according to claim 12, wherein said second supply device is arranged to supply IPA (isopropyl alcohol) as the water-soluble organic solvent, and said third supply device is arranged to supply HFE (hydrofluoroether) as the water-insoluble organic solvent.

17. The apparatus according to claim 15, wherein IPA (isopropyl alcohol) in said mixture is at most 10%.

18. A substrate treating method for treating substrates with treating liquids, comprising the steps of
moving the substrates to a treating position inside a treating tank;
cleaning the substrates with deionized water by supplying the deionized water into the treating tank and while circulating the deionized water through an inner tank and an outer tank;
replacing the deionized water with a water-soluble organic solvent by supplying the water-soluble organic solvent into the treating tank and while circulating the water-soluble organic solvent through the inner tank and the outer tank;
removing the deionized water from the treating liquids;
treating the substrates with a mixture of the water-soluble organic solvent and a water-insoluble organic solvent by supplying the water-insoluble organic solvent and a small quantity of the water-soluble organic solvent into the treating tank and while circulating the water-insoluble organic solvent and the water-soluble organic solvent through the inner tank and the outer tank; and
moving the substrates to an upper position above the treating tank.

19. The method according to claim 18, wherein the step of treating with the mixture of the water-soluble organic solvent and the water-insoluble organic solvent includes the steps of:
treating the substrates with the water-insoluble organic solvent by supplying the water-insoluble organic solvent into the treating tank and while circulating the water-insoluble organic solvent through the inner tank and the outer tank to replace the water-soluble organic solvent in the treating tank with the water-insoluble organic solvent; and
treating the substrates with the mixture of the water-soluble organic solvent and the water-insoluble organic solvent by supplying a small quantity of the water-soluble organic solvent into the treating tank and while circulating the water-soluble organic solvent and the water-insoluble organic solvent through the inner tank and the outer tank.

20. The method according to claim 18, wherein said water-soluble organic solvent is IPA (isopropyl alcohol), and said water-insoluble organic solvent is HFE (hydrofluoroether), IPA (isopropyl alcohol) in said mixture being at most 10%.
